(19) United States
(12) Patent Application Publication
(10) Pub. No.: US 2002/0019758 A1
(43) Pub. Date: Feb. 14, 2002

(54) Load management dispatch system and methods

(76) Inventor: Peter C. Scarpelli, Chicago, IL (US)

Correspondence Address: Brian J. Anderson, Esq., Morris, Manning & Martin, LLP, 1600 Atlanta Financial Center, 3343 Peachtree Road, NE, Atlanta, GA, 30326-1044, US

(21) Appl. No.: 09/795,371

(22) Filed: Feb. 28, 2001

Related U.S. Application Data
(60) Provisional application No. 60/223,742, filed on Aug. 8, 2000.

(51) Int. Cl. G06F 17/60

(52) U.S. Cl. 705/7; 705/1

(57) ABSTRACT

The load management dispatcher (“LMD”) monitors the fluctuating prices of energy and compares the market price to the economic opportunity provided to the energy consumer by curtailment of the consumer's consumption. The LMD can provide notification that the curtailment opportunity exists due to a peak in energy prices. Thus, LMD can perform an economic dispatch of distributed generation and load curtailment assets. The LMD can provide current market prices as well as the notification and acceptance of curtailment opportunities. Additionally, LMD can include the ability to monitor in near real time the energy consumption of the consumers and may be able to directly enact the energy curtailment.

### CROSS REFERENCE TO RELATED APPLICATIONS

The following U.S. patent application claims priority under 35 U.S.C. § 119 to U.S. Provisional Application Ser. No. 60/223,742 entitled “Load Management Dispatcher” filed on Aug. 8, 2000.

### TECHNICAL FIELD

The invention relates generally to the field of network-based services and, more particularly, to a load management dispatch system and method that provides economic dispatch of distributed generation and load reduction assets

### BACKGROUND OF THE INVENTION

The energy crisis in California during the winter of 2001 re-sparked the nation's interest in energy availability. Rolling blackouts dimmed sizable portions of Northern and Central California during the coldest part of a January Arctic blast. The energy shortage was exacerbated by the inability of Southern California to transmit excess energy through a bottleneck in the transmission lines through the Central Valley. The capacity of these transmission lines limits the amount of energy that can be delivered from the lower part of the state to the upper regions. As thousands went without power, the debate about California's implementation of energy deregulation heated up. As energy prices soared, California's legislated mandate, which capped the price that energy consumers could be charged, resulted in the State's two largest utilities facing potential bankruptcy.

The United States is currently in a process of deregulating the providers of energy. In a deregulated environment, energy consumers are able to buy energy from multiple energy providers. In this deregulated environment, energy prices will vary depending on demand. During peak demand periods, such as cold winters and hot summers, the price for energy can sky rocket. During these peak demand periods, the amount of commercial energy reserves diminishes and energy prices correspondingly rise. As the available commercial energy reserves dwindle to near zero, prices can escalate to record highs.

However, many energy consuming facilities have onsite generation capabilities that typically do not provide energy except in the rare event where the facility loses offsite power. Each one of these generators do not provide a monumental amount of energy, yet in the aggregate can provide a significant amount of energy. This untapped energy source can provide relief in times of commercial energy shortages.

Additionally, as energy prices escalate consumers tend to reduce their energy consumption. However, many energy consumers may have fixed price contracts that insulate the consumer from most of the effects of a varying market. These consumers have little incentive to radically reduce their energy consumption. Yet, with the proper incentive, nearly every energy consumer has the capability of significantly curtailing their energy consumption.

On the other hand, a reduction of energy consumption typically has an associated cost. For example, a factory can reduce its energy consumption by shutting down a production line. This reduction of energy consumption can result in some lost profits. Nevertheless, a cost can be calculated to determine the value associated with the consumption of energy. An evaluation can be made to determine the economic dispatch value where it becomes more advantageous to deploy an energy curtailment strategy than to operate an energy consuming mechanism. If a company can achieve greater profitability by reducing its energy consumption than by consuming the energy, many companies would opt to reduce their energy consumption. If the economic incentive is significant enough, many companies could achieve greater financial rewards by shutting down their facility completely than can be earned by the operation of the facility. If multiple energy consumers could be provided with an adequate incentive to reduce their consumption, a significant amount of energy would be available for other consumers.

Currently, energy consumers participate in the energy markets only as energy buyers. If a consumer could sell its energy reduction during peak energy price spikes, many consumers would be tempted to enhance their profits by curtailing their usage and selling the corresponding energy reduction. Onsite generation assets may be operated throughout the period when the market prices exceed the economic dispatch point of those assets. Higher prices may call for more drastic curtailment strategy, such as shutting down one assembly line and selling to the energy markets the resultant energy curtailment. Very high market prices may lead to complete curtailment and the shutdown of the energy consumer's facility. This strategy would enable the energy consumer to maximize profits by selling to the energy markets the maximum amount energy.

If energy consumers can be transformed into potential energy sellers, a significant amount of untapped energy resources can be made available during peak demand periods when the energy is needed the most. The net effect would lower peak energy prices, which would be enjoyed by all energy consumers. The energy could be available in the regions where the demand is the highest reducing the problem of transmission bottlenecks. Additionally, less power plants would need to be built to provide reserves in those limited instances of energy shortages. The total amount of energy that can be provided by aggregating all onsite generation capacity and load curtailment is phenomenal. Hence, a need exists to convert energy consumers into energy market place sellers.

### SUMMARY OF THE INVENTION

The present invention meets the needs described above in a load management dispatcher. The load management dispatcher (“LMD”) monitors the fluctuating prices of energy and compares the market price to the economic opportunity provided to the energy consumer by curtailment of the consumer's consumption. The LMD can provide notification that the curtailment opportunity exists due to a peak in energy prices. An energy consumer can decide if they want to maximize profits by reducing their supplied energy consumption. Reduction of energy consumption can be achieved by the operation of on-site generators or by shedding energy consuming loads. Thus, invention performs an economic dispatch of distributed generation and load curtailment assets.

The LMD can provide current market prices as well as the notification and acceptance of curtailment opportunities. Additionally, LMD can include the ability to monitor in near real time the energy consumption of the consumers and may be able to directly enact the energy curtailment.

Generally described, the invention is a system and method for energy load curtailment. The LMD obtains energy market buying prices and an economic setpoint based upon a cost associated with an energy load reduction by an energy consumer. The energy consumer can calculate a profit margin obtainable by the use of supplied energy made available by an energy provider. At a certain price, it becomes economically advantageous for the energy consumer to not consume energy, but instead, sell the energy on the open market. The economic setpoint is based upon and is typically higher than the calculated value where it becomes advantageous to sell a reduction of energy consumption to the energy buying markets. The economic setpoint can be obtained from an energy provider, directly from an energy consumer, or from any other market place participant.

Typically, the energy market prices are obtained via the Internet. After obtaining the energy market buying prices and the economic setpoint, the LMD compares the values to determine if an economic dispatch opportunity exists.

If an economic dispatch opportunity exists, the LMD can transmit a notification indicating that the energy market buying prices has exceeded the economic setpoint. The notification is typically provided to the energy market participant that supplied the economic setpoint. A notification can be transmitted to any marketplace participant including an energy provider or an energy consumer. Hence, the LMD can provide a notification indicating that the energy market buying prices has exceeded a profit margin obtainable by an energy consumer through the use of supplied energy made available by an energy provider. In addition to a notification transmittal, the LMD can transmit a signal that automatically effectuates the load reduction. Load reduction or curtailment can be accomplished by the operation of an onsite power generator, connecting an energy consuming mechanism to an onsite battery supply or connecting an energy consuming source to any energy storage device, utilizing onsite stored gas supplies rather than consuming gas supplied by an energy provider, removing or shedding an energy consuming source, shutting down a production line or facility, or any other means to curtail energy consumption from an energy provider.

As part of providing load curtailment management, the LMD can monitor the energy load reduction by the energy consumer. The monitoring can include receiving meter readings in near real time, obtaining meter readings from a database, or other means for collecting energy load reduction information. From the energy load reduction information, the LMD can calculate payment information including calculating a credit to be applied to a bill for the energy consumer. This payment information can be transmitted to any market participant including the energy consumer or the energy provider.

The invention is typically implemented by a computer system. The computer system can receive the economic setpoint and can receive energy market buying prices via a computer network. The computer system compares the energy market buying prices to the economic setpoints. Upon identification of an economic dispatch opportunity, the computer system can initiate a notification by any communication means that can provide a notification to the energy market participant that an economic dispatch opportunity exists.

### BRIEF DESCRIPTION OF THE DRAWINGS

FIG. 1 is a functional block diagram illustrating a load management dispatch system.

FIG. 2 is a functional block diagram illustrating an LMD software architecture.

FIG. 3 is a functional block diagram illustrating a LMD hardware architecture.

FIG. 4 is a functional block diagram illustrating basic message formats for communications.

FIG. 5 is a functional block diagram illustrating a data file structure for information stored in association with the LMD database.

FIG. 6 is a logic flow diagram illustrating a main dispatch process.

FIG. 7 is a logic flow diagram illustrating a load management dispatch routine.

FIG. 8 is a logic flow diagram illustrating an energy consumer dispatch routine.

FIG. 9 is a logic flow diagram illustrating a curtailment routine.

FIG. 10 is a logic flow diagram illustrating an administrative routine.

FIG. 11 is a screen shot illustrating a LMD dashboard.

FIG. 12 is a screen shot illustrating a customer credit summary page.

FIG. 13 is a screen shot illustrating a customer-listing page.

FIG. 14 is a screen shot illustrating a view trades page.

FIG. 15 is a screen shot illustrating a curtailment notification page.

FIG. 16 is a screen shot illustrating a curtailment-monitoring page.

### DETAILED DESCRIPTION OF THE EMBODIMENTS

The described embodiment discloses a system that provides an efficient management of a load curtailment program. The load management dispatcher is designed to economically dispatch energy consumer's load management assets based upon price signals from the market. Although the described embodiment refers to a load management dispatch system in an electrical energy context, those skilled in art can readily appreciate that the system is equally advantageous with other energy commodities including natural gas.

If the market price exceeds the consumer's load shedding cost or self-generating cost, it can be more economically advantageous for the energy consumer to reduce its usage by deploying its load management strategy than to take power from the grid. The energy consumer can reduce its load demand and have its energy provider sell the energy to an energy market. Upon reduction of an energy consumer's load, the energy provider no longer is required to supply the grid with the amount of energy corresponding to the consumer's curtailment. Since the energy provider has previously arranged for this energy to be supplied to the grid, the energy provider can market this available energy to other market participants.

The system allows market participants to react to, and profit from, fluctuations in hourly market prices. The system is a dynamic process that delivers the energy market to the energy consumer. The energy consumer can directly profit from changes in market. The system provides energy consumers with the ability to directly participate in the energy market as a seller rather than merely as a buyer. In addition, wide spread usage of the system can yield significant societal benefits in tapping previously unidentified energy assets.

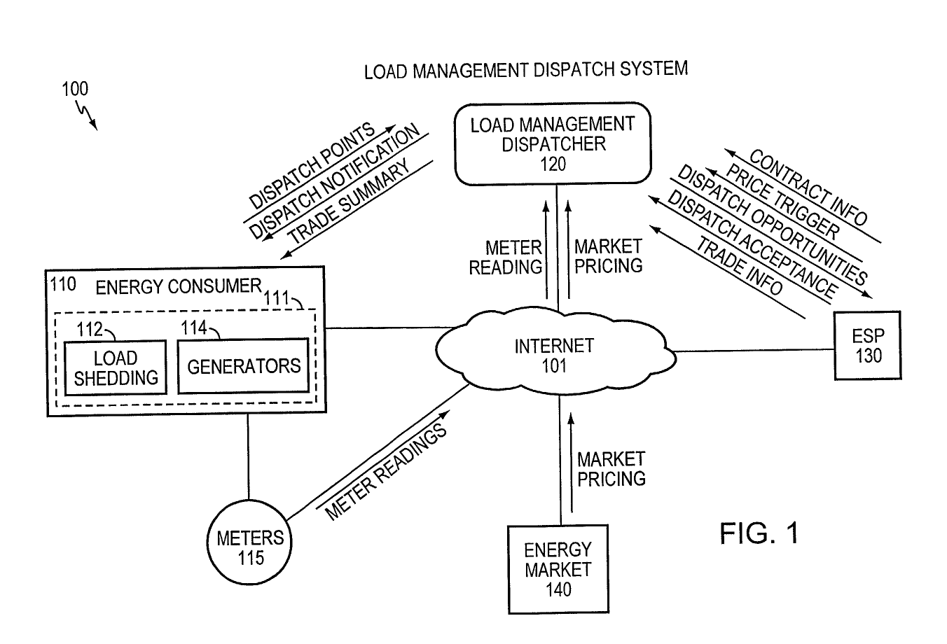

Turning to the figures, in which like numerals indicate like elements throughout the several figures, FIG. 1 illustrates a load management dispatch system 100 constructed in accordance with an embodiment of the present invention. The system 100 is connected for computer communications via a known global computer network commonly known as the Internet 101. It is known in the art to send packets of information via the Internet. One common known protocol for the transfer of data via the Internet 101 is the Transfer Control Protocol/Internet Protocol (TCP/IP).

The disclosed load management dispatch system 100 provides a system for economic dispatch of energy consumers' load management assets 111. An energy customer 110 can manage its energy load by reducing consumption or utilizing its energy reserves. Common methods of supplied energy curtailment encompass deploying load shedding assets 112 and operating on-site generators 114. Those skilled in the art will recognize that energy curtailment can be accomplished by other mechanisms. Significant monetary savings can be achieved by the deployment of load management assets 111 during periods of spiked energy prices.

The energy consumer 110 contracts with an energy service provider (“ESP”) 130, also referred to as an energy provider, to provide the consumer 110 with its energy needs. Energy service providers 130 are entities that have title to electrical power and energy. Energy service providers 130 include local distribution companies and utility distribution companies. The ESP 130 uploads a load forecast based upon its energy consumers' predicted demand to the control area operator (not illustrated). The control area operator (not illustrated) has the responsibility of grid management. Additionally, the ESP 130 contracts with electrical generation companies (not illustrated) to provide the grid with scheduled amount of energy.

The ESP 130 signs a load management contract with the energy consumer 110. The load management contact includes the revenue sharing terms of a load curtailment by the energy consumer 110. The revenue sharing can be a fixed price per megawatt, a percent of the sales price over the operating expense of the curtailment, or any other revenue sharing model. The cost to the energy consumer 100 to operate its on-site generation capabilities or to shed load is an economic dispatch point for that energy consumer.

Clearly, the energy consumer can have multiple economic dispatch points. For example, it may be economical to run on-site generators 114 at a lower economic dispatch point then shutting down a production line, a load shedding asset 112. At a higher economic point, it may be economically advantageous to shut down a production line and sell the resulting load curtailment. Finally, as prices increase, it may become economically advantageous to shut down the entire plant. In any event, at certain defined energy prices, it becomes more profitable to curtail load demand and sell the resulting excess energy on the energy market.

Additionally, the load management contract terms can include mandatory curtailment requirements in exchange for cheaper rates. The ESP 130 electronically provides the load management contract terms to the load management dispatcher (“LMD”) 120. The information provided to the LMD 120 includes the energy consumer's economic dispatch points and the contract settlement arrangements. The described embodiment contemplates that that electronic data will be transmitted in a known manner via the Internet 101.

The LMD 120 monitors the market pricing for the energy commodity. The disclosed embodiment contemplates establishing a real time connection to the various energy markets 140 in a known manner via the Internet 101. The energy markets provide the price for energy at which energy service providers 130 are willing to buy during each hour.

The LMD 120 also monitors the energy consumers' usage. A consumer's load management performance can be measured by the difference of the consumer's projected load minus their actual load during an event or by a measurement of the actual self-generated output. Preferably, the energy consumer 110 has installed meters 115 that can provide real time usage data directly to the LMD 120 over the Internet 101. However, meters 115 can also be read periodically with the data transmitted after the termination of a curtailment event. In any event, meters 115 track the energy consumers curtailment performance, and the curtailment data is obtained by the LMD 120.

The ESP 130 determines a market price trigger point, also referred to as the alarm price, based upon the contract terms with its various energy consumers 110. When the market price exceeds the trigger point, the LMD 120 notifies the ESP 130. The notification can be accomplished by an e-mail delivered by the Internet 101. Other contemplated notification means include an automatically generated telephone call, a facsimile, a wireless communication delivered via a wireless transmitter to a pager, mobile phone, or other wireless device, a wireless message delivery by wireless application protocol (WAP) to a hand held computing device, or other suitable methods for delivering message to the ESP 130. The ESP decides whether to act upon the notification.

If the ESP 130 decides to act upon the notification, the ESP 130 informs the LMD 120 of which customer groups to notify of the curtailment opportunity. The ESP 130 can inform the LMD 120 of the consumer groups to notify by electronically transmitting a file in a known manner via the Internet. Alternatively, the system contemplates that the ESP 130 can access, by known operation of a web browser, a notification tool at the web site operated by the LDM 120. The notification tool can automatically contact the energy consumer. The notification can be accomplished by an e-mail delivered by the Internet 101. Other contemplated notification means include an automatically generated telephone call, a facsimile, a wireless communication delivered via a wireless transmitter to a pager, mobile phone, or other wireless device, a wireless message delivery by wireless application protocol (WAP) to a hand held computing device, or other suitable methods for delivering message to the energy consumer 110.

In addition, if the energy consumer 110 has a mandatory reduction obligation, the LMD can generate and transmit a signal that will automatically effectuate the load curtailment. An automated reduction will be most desirable in unmanned or remote facilities.

The energy consumer 110 decides whether to accept or decline the curtailment notification. However, some contracts may include terms that may not allow the energy consumer to decline the curtailment notification. The energy consumer 110 notifies the LMD 120 of its response to the curtailment notification. The disclosed embodiment contemplates the consumer operating a web browser in a known manner to access the consumer notification tool maintained by the LMD 120.

The energy consumer's response is provided in a known manner to the ESP 130. The LMD 120 identifies the total amount of load that should be reduced. Typically, the ESP 130 sells the amount of the anticipated load reduction in the non-firm hourly market. The aggregated energy consumer performance is monitored. If an energy consumer 110 under/over performs the ESP 130 can adjust its non-firm trade, or it can default to the energy imbalance market. . The ESP records the trade in the LMD 120. Typically, the ESP 130 provides the price, quantity, and the associated hour. The LMD 120 calculates the energy consumer payment based upon the load management contract terms. The energy consumer 110 can access the trade information at the LMD web site by the known operation of a web browser.

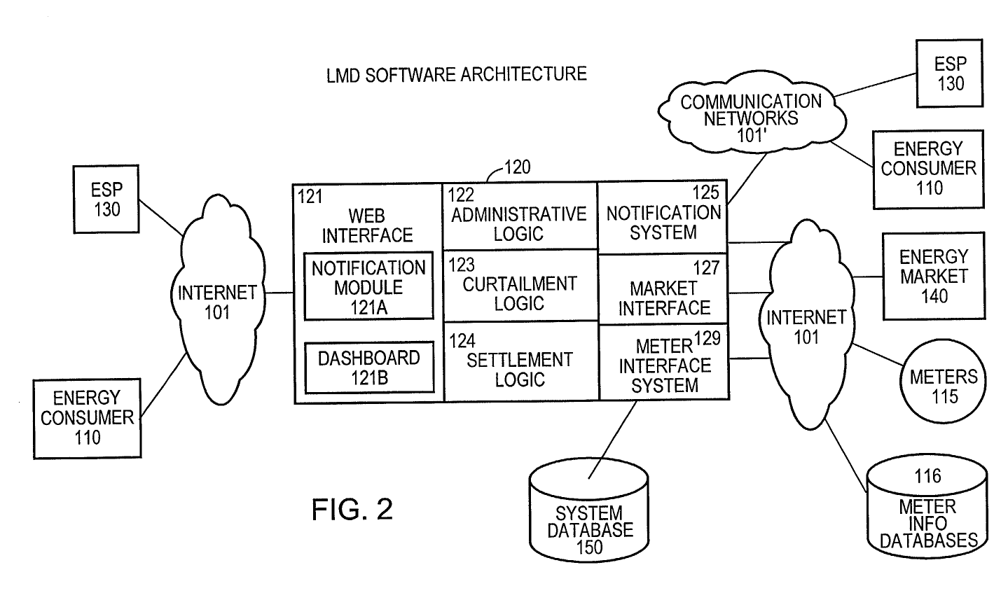

FIG. 2 and the subsequent figures provide illustrations for a discussion of a series of message formats, data structure diagrams, hardware and software architectures, process diagrams in the form of flow charts, and user interface screen shots that illustrate an exemplary embodiment of a system and corresponding methods for the disclosed load management dispatch system 100.

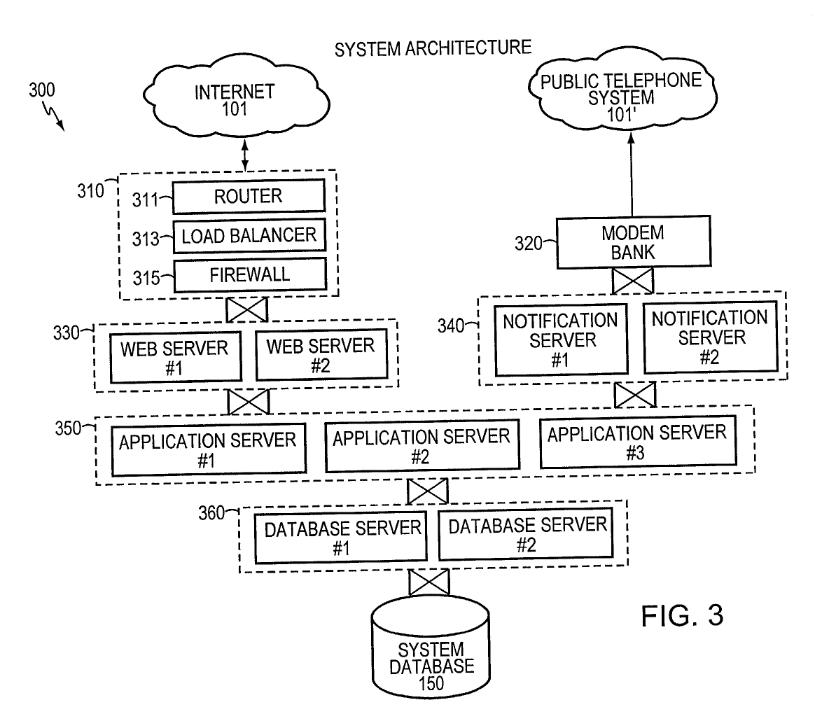

FIG. 2 discloses a logical software architecture of the load management dispatcher 120 constructed in accordance with an embodiment of the present invention. As will be understood in the art, the system is constructed utilizing Internet-enabled computer systems with computer programs designed to carry out the functions described herein. The computer programs are executed on computer systems constructed as described in reference to FIG. 3. Although the disclosed embodiments are generally described in reference to Internet-accessible computers including the load management dispatch system 100, those skilled in the art will recognize that the present invention can be implemented in conjunction with other program modules for other types of computers.

The disclosed embodiment of the present invention is implemented in a distributed computing environment such as the Internet. In a distributed computer environment, program modules may be physically located in different local and remote memory storage devices. Execution of the program modules may occur locally in a stand-alone manner or remotely in a client/server manner. By way of illustration and not limitation, distributed computing environments include local area networks (LAN) of an office, enterprise-wide area networks (WAN), and the global Internet (wired or wireless connections). Accordingly, it will be understood that the terms computer, operating system, and application program include all types of computers and the program modules designed to be implemented by the computers.

The discussion of methods that follows, especially in the flow charts, is represented largely in terms of processes and symbolic representations of operations by conventional computer components, including a central processing unit (CPU), memory storage devices for the CPU, connected display devices, and input devices. Furthermore, these processes and operations may utilize conventional computer components in a heterogeneous distributed computing environment, including remote file servers, remote computer servers, and remote memory storage devices. Each of these conventional distributed computing components is accessible by the CPU via a communication network.

The processes and operations performed by the computer include the manipulation of signals by a CPU, or remote server such as an Internet web site, and the maintenance of these signals within data structures reside in one or more of the local or remote memory storage devices. Such data structures impose a physical organization upon the collection of data stored within a memory storage device and represent specific electrical, optical, or magnetic elements. These symbolic representations are the means used by those skilled in the art of computer programming and computer construction to effectively convey teachings and discoveries to others skilled in the art.

For the purposes of this discussion, a process is understood to include a sequence of computer-executed steps leading to a concrete, useful, and tangible result, namely, the effecting of an economic dispatch of load management assets.

These steps generally require manipulations of quantities such as market prices, meter data, dispatch set-points, acceptance information, megawatts traded, associated dollar values, identifiers of clients, consumers and premises, and other related transactional information. Usually, though not necessarily, these quantities take the form of electrical, magnetic, or optical signals capable of being stored, transferred, combined, compared, or otherwise manipulated. It is conventional for those skilled in the art to refer to these signals as bits, bytes, words, values, elements, symbols, characters, terms, numbers, points, records, objects, images, files or the like. It should be kept in mind, however, that these and similar terms should be associated with appropriate quantities for computer operations, and that these terms are merely conventional labels applied to quantities that exist within and during operation of the computer.

It should also be understood that manipulations within the computer are often referred to in terms such as displaying, deciding, storing, adding, comparing, moving, positioning, placing, and altering which are often associated with manual operations performed by a human operator. The operations described herein include machine operations performed in conjunction with various input provided by a human operator or user that interacts with the computer. In addition, it will be understood that the programs, processes, routines and methods described herein are not related or limited to any particular computer or apparatus, nor are they related or limited to any particular communication network architecture. Rather, various types of general-purpose machines may be used with program modules constructed in accordance with the teachings described herein. Similarly, it may prove advantageous to construct a specialized apparatus to perform the method steps described herein by way of dedicated computer systems in a specific network architecture with hard-wired logic or programs stored in nonvolatile memory, such as read only memory.

With the foregoing in mind, the drawing figures starting with FIG. 2 illustrate various functions, processes, or routines carried out by an embodiment of the present invention in which the disclosed load management dispatch system 100 carries out the functions described in connection with the flow charts and database maintenance. The functions or processes in these figures are carried out in the disclosed embodiment of the present invention by software executing in computers associated with energy service providers 130, energy consumers 110, the LMD 120, and various energy markets 140. Depending upon the particular operation, the computers are connected for data communications via a network such as the Internet 101 or for communications via a communication network 101 such as the public phone system (POTS). It will also be understood that the processes and methods presented here may be arranged differently, or steps taken in a different order. In other words, some processes and methods may be deleted, repeated, re-ordered, combined, or blended to form similar processes and methods.

Referring specifically now to FIG. 2, the principal software modules or components of the LMD 120 include a web interface 121, an administrative logic unit 122, a curtailment logic unit 123, a settlement logic unit 124, a notification system 125, a market interface 127, and a meter interface 129.

The web interface 121 is operative to receive communications via the Internet 101 from at least one energy service provider 130 and from at least one energy consumer 110. Web communications from the energy service provider 130 are in connection with curtailment events, consumer accounts, and energy consumer notifications. While communications with the energy consumer 110 are primarily of an administrative nature that enable the energy consumer to review curtailment event histories and to accept curtailment notification.

In particular, the web interface 121 provides Internet-accessible interfaces for the notification module 121A, for the dashboard 121B, and for electronic file transfers.

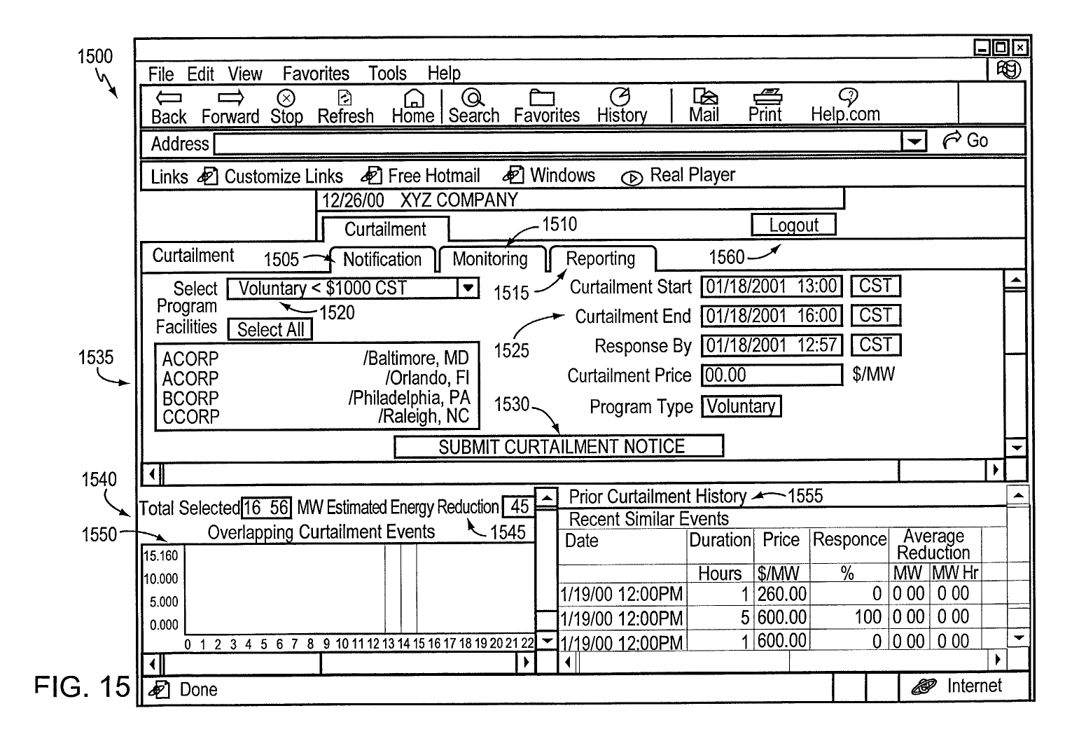

The notification module 121A allows an energy service provider 130 to select the energy consumers 110 which are to notified about a curtailment opportunity. A screen shot of one graphical interface of the notification tool for an ESP 130 is illustrated in reference to FIG. 15. The notification module 121A enables the energy service provider 130 to report curtailment event details to the selected energy consumers 110. The energy consumers 110 can also access the notification module 121 A to accept or decline the curtailment opportunity.

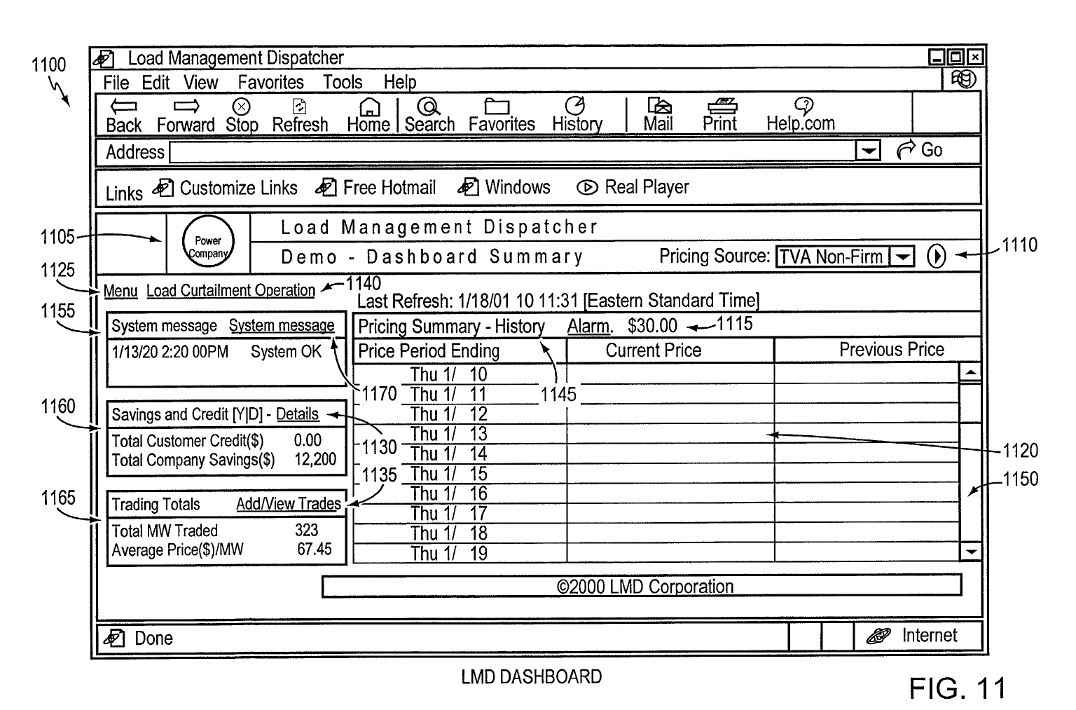

The dashboard 121B provides access via a web browser to trading histories, savings and credit information, system messages, and market prices. A screen shot of the graphical interface of one dashboard for an user at an ESP 130 is illustrated in reference to FIG. 11. The web interface 121 is also operative to receive electronic files in connection with account management, dispatch notification acceptance, and the creation of new customer accounts. These communications can take the form of multiple dialogues including Electronic Data Interchange (EDI), Extensible Markup Language (XML), and custom flat file formats.

The administrative logic unit 122 is operative to respond to communications, typically via web browser or electronic files, for the purpose of administrative functions. These functions include setting up employees as account users with the authority to authorize transactions, account management, editing of profiles, creation of new accounts, and addition of new energy consumers.

The curtailment logic unit 123 is operative to compare information from various energy markets 140 against the price trigger provided by the ESP 130. The curtailment logic unit 123 is operative to calculate the expected curtailment and generate the automatic notification of ESP of the curtailment opportunity. The unit is responsive to the acceptance or the decline of the curtailment opportunity notification. In connection with a refusal, the unit closes the curtailment opportunity process. In connection with acceptance from curtailment opportunity notification, the unit 123 generates an automatic dispatch notification to the selected energy consumers. The curtailment logic unit notifies the ESP of the energy consumer response.

The settlement logic unit 124 is operative in response to an acceptance by the energy consumer 110 of a dispatch notification. The settlement logic unit is operative to monitor the curtailment of the energy consumer. The unit is operative to provide the ESP with the curtailment performance information via the web interface 121. The settlement logic unit 124 also is operative to automatically send an alarm to the energy consumer via the notification system 125 if the expected curtailment is not achieved. The unit 124 is operative to receive from the web interface the final trade information from the ESP. The unit 124 is operative to calculate from the trade information the credit owed to the energy consumer. The settlement unit updates the files for display via the web interface.

The notification system 125 is operative to communicate curtailment opportunities to the ESP 130 and dispatch notifications to the energy consumer 110. The notification can be accomplished by an e-mail delivered by the Internet 101. Other notification means include an automatically generated telephone call, a facsimile, a wireless communication delivered via a wireless transmitter to a pager, mobile phone, or other wireless device, a wireless message delivery by wireless application protocol (WAP) to a hand held computing device, or other suitable methods for delivering messages.

The market interface 127 provides communication links to the various energy markets 140. The market interface 127 receives signals from actively traded power exchanges, energy service provider trading desks, and independent system operators. The data received includes market price, associated time interval, and whether the price is firm or not firm. The meter interface system 129 is operative to receive meter information transmitted via the Internet or to access and retrieve the information from meter databases 116 in which the meter information resides.

A system database 150 forming a part of the system 100 stores information required for implementing the present invention.

According to an aspect of the invention, the computer programs described above collectively provide functions or components that form a load management dispatcher that provides economic dispatch of load curtailment opportunities. Greater details of these various functions and software components are described in subsequent FIGs.

FIG. 3 illustrates an embodiment 300 of a hardware architecture of a load management dispatcher 120 constructed in accordance with the invention. As described in connection with FIG. 2, the LMD 120 communicates with energy consumers 110, energy service providers 130, energy markets 140, and energy meters 115 via the Internet 101 and when appropriate, other communication systems 101′ such as the public telephone system.

Internet communications with the LMD 120 are effected by an Internet front end 310 including a router 311, a load balancer 313, and a firewall 315. The router 311 is operative in the known manner to send and receive data packets, typically in the form of TCP/IP packets commonly used for Internet communications. The load balancer 313 operates in known manner to balance the load from various communications amongst a plurality of computers or servers that are employed to construct the LMD 120. The data packets pass through a firewall 315, which ensures the overall security in a known manner before being passed to the web servers 330. The web servers 330 include a plurality of redundant similarly configured computers, two of which are illustrated, that are operative to implement the front end software. The web servers 330 are operative to direct on-line transactions, receive market pricing information, retrieve meter reading information, and display information to users operating a web browser. The web servers 330 are coupled to application servers 350.

The application servers 350 include a plurality of redundant similarly configured servers, three of which are illustrated, that are operative to implement the application software. The application servers 350 are operative to implement the administrative logic software 122, curtailment software 123, and settlement software 124. The application servers 350 are coupled to the web servers 330, the notification servers 340, and the database servers 360.

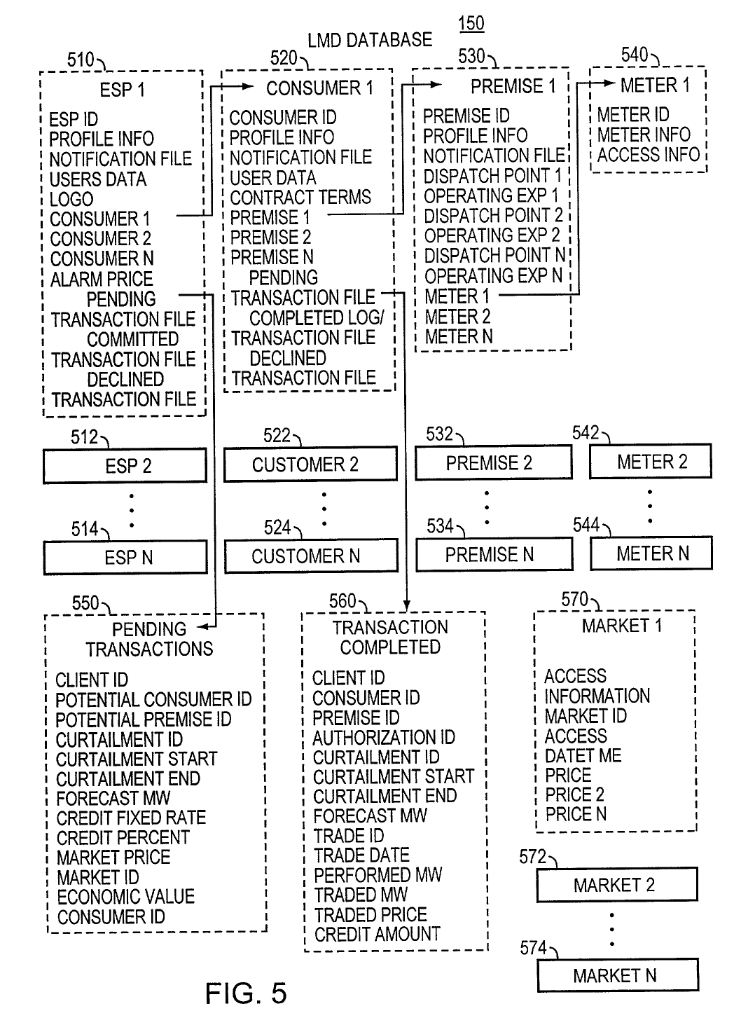

The database servers 360 include a plurality of redundant similarly configured servers, two of which are illustrated, that are operative to store and retrieve information from a database 150. The database servers are coupled to the application servers. Further details of the information stored in the database is provided in connection with FIG. 5.

The notification servers 340 include a plurality of redundant similarly configured servers, two of which are illustrated, that are operative to provide non-Internet communications with the energy consumers 110 or energy service providers 130. The notification servers 340 are coupled to the application servers 350 and a bank of modems 320. The modem bank 320 provides the communication link between the notifications server 340 and the notification system 101′ such as the public telephone system for the transmission of automatically generated facsimiles, pages, or telephone communications.

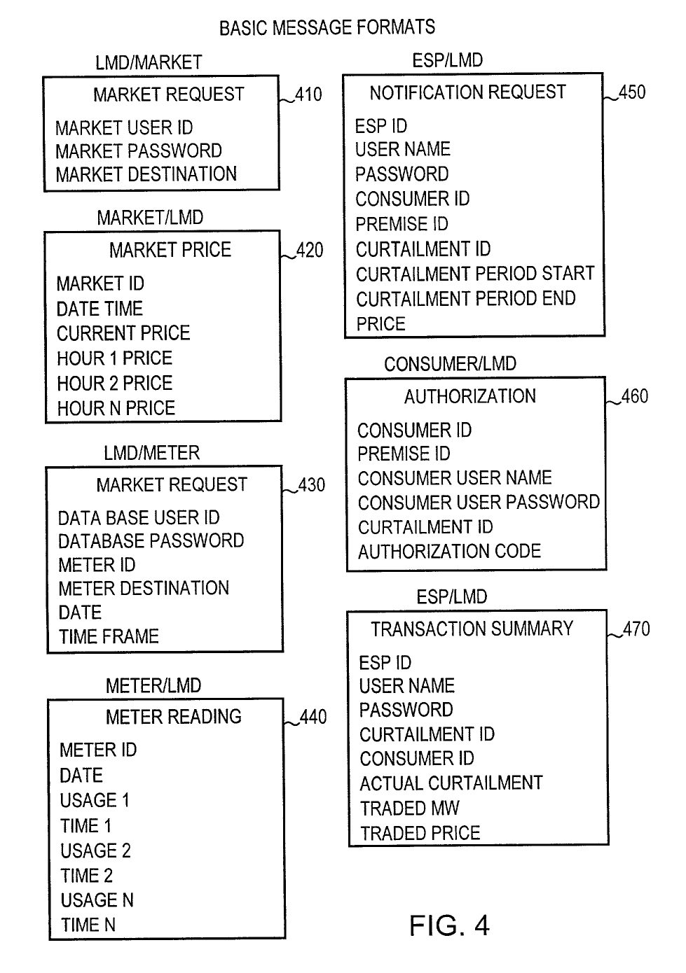

FIG. 4 illustrates the logical construction of some possible basic message formats that are passed between the various entities in the load management dispatch system 100. Basic communications are exchanged between the LMD 120 and the energy markets 140, meters 115, energy service providers 130, and energy consumers 110. These communications can take the form of multiple dialogues including Electronic Data Interchange (EDI), Extensible Markup Language (XML), and custom flat file formats. Additionally, some of these communications can be effected by way of a web browser interacting with the web interface residing on a web server. Alternately, statements, notifications, reports, and other communications can be accomplished by e-mail and other electronic means.

In regard to communications between LMD 120 and the energy markets 140, there are at least two basic communications: a request for market information and the provision of market price information. A market request 410 includes information associated with the requester. The market request 410 includes the requestor's market user identification and the associated password or security information to enable access. The request may include the destination location to which the market information should be sent.

After a request for information is received, the energy market 140 provides the market price communications 420. The market price communications 420 includes the market identifier, the date and time of the update, hourly prices with an indication of whether the price is firm or not.

Likewise, communications between the LMD 120 and a meter database 115 with the meter usage information include a meter request 430 for the information and the provision of the meter reading information. The meter request 430 includes the user identifier and associated password or other security information to access the data. The meter request 430 specifies the meter identifier to identify the requested meter. The request also includes the destination to which the data should be transmitted.

The provided meter readings 440 from the meter database 115 includes the date of the reading, the time of the reading, and the actual energy consumption or energy produced by on-site generation.

Upon the determination to proceed with a curtailment opportunity, the energy service provider 130 communicates with the LMD 120 to provide a notification request 450. The notification request 450 can be effectuated by interfacing with the LMD 120 via a web browser or by the receipt of a notification request file. The notification request 450 includes the ESP identifier making the request. The notification request 450 also provides the user name of the person authorizing the request and the associated password or other security measure. The notification identifies the consumer by the consumer identifier and in some circumstances the premise by the premise identifier. The notification states the curtailment identifier provided by the LMD 120 that identifies the curtailment opportunity. The curtailment period start and the curtailment period end are also included. The notification request 450 may also include the associated market price for the curtailment.

The energy consumer 110 authorizes or declines the dispatch notification with an authorization message 460. This information can be effectuated by interfacing with the LMD 120 via a web browser or by the transmission of an authorization file. The authorization 460 includes the consumer identifier and the premise identifier if applicable. The consumer user providing the authorization supplies his user name and associated password for verification of the authority to bind the energy consumer 120. The authorization 460 includes the curtailment event identifier and an authorization code indicating an acceptance or a refusal of the dispatch. The energy service provider 130 concludes a curtailment event with the provision of the actual transaction data summary to the LMD 120. This information can be effectuated by interfacing with the LMD 120 via a web browser or by the transmission of a transaction summary file. A transaction summary 470 includes the ESP identifier and related security information such as user name and password. The transaction identifies the curtailment event by its associated curtailment identifier. The energy service provider 130 transmits details about the actual curtailment, the traded energy, and actual transaction price of the curtailment event.

FIG. 5 illustrates a data file structure of information stored in the LMD database 150. The information illustrated in FIG. 5 is organized logically in conventional data files in the known manner, associated with one or more energy service providers 130 and one or more energy markets 140.

The LMD 120 stores information associated with a plurality of different energy service providers, e.g. ESP 1 510 , ESP 2 512 , through ESP N 514, and a plurality of markets, e.g. MARKET 1 570, MARKET 2 572, through ESP N 574. Energy service providers 130 are associated with energy consumers 110, e.g. CONSUMER 1 520, CONSUMER 2 522, through CONSUMER N 524. Likewise, energy consumers 110 may be associated with a plurality of premises, e.g. PREMISE 1 530, PREMISE 2 532, through PREMISE N 534. The energy consumer 110 or associated premise is associated with meters 115, e.g. METER 1 540, METER 2 542, through METER N 544, for monitoring of the performed load curtailment. Information stored in the database 150 can be retrieved for data manipulation and reporting.

In accordance with one disclosed embodiment, each energy service provider 130 has certain information associated with it. Illustrated is information stored in connection with a file for ESP 1 510. Such information includes the company profile. Profile information identifies the company such as by mailing address, billing information, and general contact points. The LMD 120 assigns each ESP 130 a, ESP identifier to facilitate identification of the energy service provider 130 during communications. An ESP notification file is also associated with each ESP that contains the contact information for authorizing proceeding with an opportunity or declining a curtailment opportunity. Each ESP designates the employees that can authorize certain transactions. The authority level along with a user name and associated password or other security information are stored as user data.

Many energy service providers 130 will desire to present to its various consumers its logo and other branding information. Consequently, when establishing communication with their consumers, the branding information stored in association with the ESP 130 is displayed. Each energy service provider 130 will have a plurality of energy consumers 110 associated with the ESP 130, and each energy consumer 110 will have its own information associated with that consumer. Additionally, an alarm price is associated with each ESP 130. Optionally, the alarm price can be associated with a consumer or a group of energy consumers that are associated with an ESP 130. When the market price exceeds the alarm price, the energy service provider 130 is notified of a curtailment opportunity. The information about the curtailment opportunity is stored in a pending transaction file 550.

The pending transaction action file 550 stores information about a curtailment event so that the information can be presented to the ESP 130. If the ESP 130 declines to act on a curtailment opportunity, the pending file 550 is closed and a declined transaction file (not illustrated) is updated. The declined transaction file (not illustrated) includes data concerning the curtailment opportunity. Upon completion of a curtailment event, the LMD updates a completed transaction file 560.

The pending transaction file 550 contains information about a current curtailment event. When an energy service provider alarm price is exceeded by a market price, a pending transaction file 550 is created, and a curtailment identifier is assigned. The information contained in the file 550 includes the client identifier of the energy service provider and the potential consumers identifier. The curtailment start and end time are identified. A forecast energy curtailment is calculated based upon the stored information known about the premises. Based upon the forecast curtailment, an economic value to the energy consumer can be calculated based upon the credit fixed rate or the credit percentage included in the contract terms. The market price and the associated market identifier are also associated with the pending transaction. When the ESP 130 proceeds with a curtailment opportunity, the energy consumers 110 designated for notification by the ESP 130 are associated with the pending transaction file 550.

Each energy service provider 130 has a plurality of energy consumers 110 associated with the ESP 130. Illustrated is information associated with a CONSUMER 1 file 520. Each consumer 110 is assigned by the LMD 120 a consumer identifier. Stored in the file 520 in connection with the consumer 110 is the consumer's profile information, notification information, and user data. Consumer's user data includes the user names, associated passwords, and authorization ability to accept or decline dispatch notifications. Each consumer 110 has one or more premises associated with the consumer 110. Premise specific information may be stored in an associated premise file 530. Additionally, each energy consumer 110 also has its relevant contract terms with its associated ESP 130 stored by the LMD 120.

The contract terms include the information on the price sharing with the ESP 130 and whether a curtailment is mandatory or voluntary. A consumer 110 has a fixed cost associated with any curtailment management strategy. For example, the energy consumer 110 knows the cost associated with running of an on-site generator or the economic loss associated with shutting down a production line. This cost is the dispatch point above which a load management deployment becomes economically advantageous. The contract terms specify how to share in the revenue generated by a curtailment above the dispatch point. The customer can be paid a fixed rate for load curtailment or split revenue with the ESP 130 based upon a credit percentage allocation.

When an ESP 130 determines to notify a consumer about a curtailment opportunity, the designated consumers are associated with a pending transaction file 550. If the consumer declines a dispatch notification, the declined transaction file (not illustrated) is updated. The declined transaction file (not illustrated) includes information that can be provided to the consumer about the lost economic curtailment opportunity. Upon the completion of a transaction, the associated completed transaction file 560 is updated.

The completed transaction file 560 associates the curtailment event with the corresponding ESP 130 and energy consumers 110. The curtailment identifier, the ESP identifier, the consumer identifiers, and any corresponding premise identifiers are associated with the completed transaction file 560. The transaction file 560 will include the date, curtail start and end times, and the estimated energy curtailment. The file 560 also includes the actual trade data provided by the ESP or other market participant. For example. the market clearing prices or the trade price can be provided by a regional Independent System Operator or a power exchange. The trade data includes the trade identifier, the amount of energy traded, trade price, and actual credit amount received by the consumer.

Each energy service provider 130 has an associated at least one associated premise. Illustrated is information stored in connection with a PREMISE 1 file 530. The premise information is stored in association with the corresponding consumer. The premise information includes the premise identifier assigned by the LMD 120 and standard profile information. Each premise has at least one dispatch point and a corresponding operating expense as explained above. Additionally, each premise has at least one meter 115 associated with the premise to monitor the curtailment performed by the premise.

Each meter 115 has a meter identifier associated with the meter 115 to facilitate identification. Illustrated is information stored in connection with a file 540 for METER 1. If the meter 115 is capable of providing real time measurements via the Internet, the LMD 120 can readily store these meter readings. Otherwise, the access information for the meter 115 is stored. The access information includes the URL of the database with the meter readings and the access authorization information.

The LMD 120 monitors various energy markets 140 for dispatch opportunities. Illustrated is information stored in connection with a file 570 for MARKET 1. The access information and a corresponding market identifier associated with each energy market 140 are stored. The access information enables the LMD 120 to access the market prices provided by the energy market 120. This access information can include the URL and any associated access authorization data. The LMD 120 also stores the market information such as the market price and the corresponding date and time.

An electronic dashboard accessible by the operation of a web browser can provide energy consumers 110 or energy service providers 130 with an easy mechanism to view or, in limited circumstances, edit most of the data stored by the LMD 120.

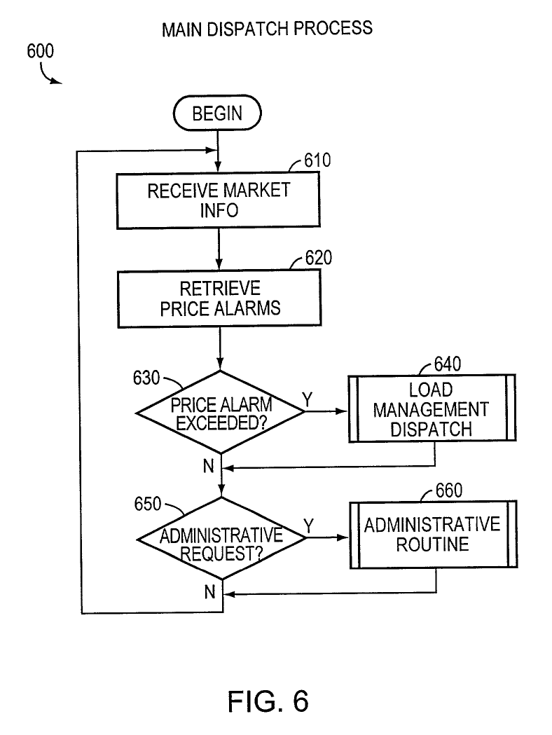

FIG. 6 discloses the various processes that are carried out with a load management dispatcher. FIG. 6 specifically illustrates a main dispatch process 600, which include the major steps taken by the LMD.

Beginning at 610, the LMD receives market information from the various energy markets. In order to electronically receive the market pricing information, the LMD must initiate contact with each energy market, Most markets have web interfaces that provide real time price information. Energy deregulation is causing the formation of additional power exchanges or other market mechanisms to acquire price information. For example, price information can be provided by an Independent System Operator for markets that currently do not have price visibility.

Step 610 is followed by step 620, in which the LMD retrieves from the system database the alarm prices for each energy service provider. Energy service providers typically supply the LMD with multiple alarm price notification set-points. Energy service providers generally create different response levels with each of their respective energy consumers. Onsite generation assets may be operated throughout the period when the market prices exceed the economic dispatch point of those assets. Higher prices may call for more drastic curtailment strategy, such as shutting down one assembly line. Very high market prices may lead to complete curtailment and the shutdown of the energy consumer's facility. The energy service providers determine their alarm prices based upon the economic dispatch points of their energy consumers.

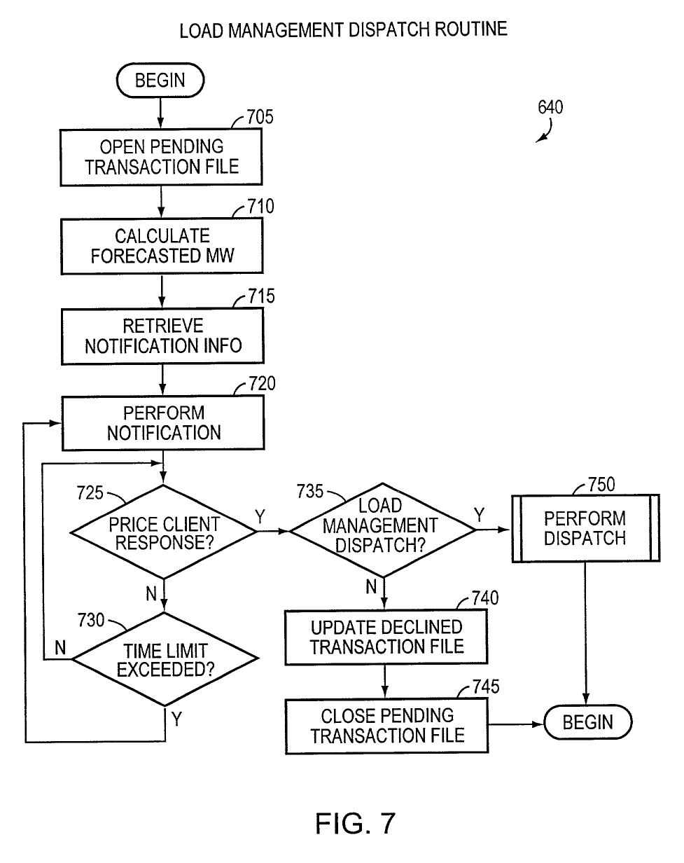

Step 620 is followed by step 630, in which the LMD compares the supplied alarm price to the market prices. If the market price exceeds the alarm price, the Y (yes) branch of step 630 is followed to routine 640, in which the LMD performs a load management dispatch. Routine 640 is described in greater detail in reference to FIG. 7. Routine 640 is followed by step 650, in which the LDM determines if it has received an administrative request. If the market price does not exceed the alarm price, the N (no) branch of step 630 is followed to step 650.

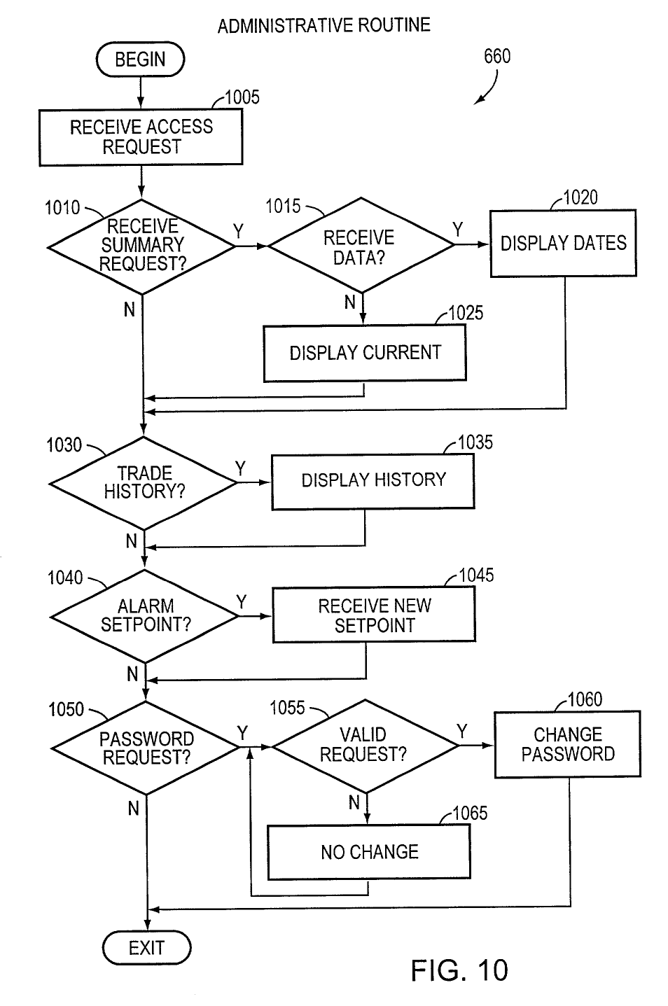

At step 650, the LMD determines whether it has received an administrative request. If the LMD has not received an administrative request, the N (no) branch of step 650 is followed to step 610, in which the process repeats itself in a continuous cycle. If the LMD has received an administrative request, the Y (yes) branch of step 650 is followed to routine 660, in which the LMD performs the administrative request. Routine 660 is described in greater detail in reference to FIG. 10. Routine 660 is followed by step 610, in which the process repeats itself in a continuous cycle.

FIG. 7 illustrates a load management dispatch routine 640, which is carried out in response to market prices exceeding an energy service provider alarm price.

Beginning at step 705, the LMD opens a pending transaction file to store information about the curtailment opportunity. Step 705 is followed by step 710, in which the LMD calculates the proposed energy curtailment. As part of a load management strategy, energy consumers have determined the economic dispatch point for their on-site generation or their load shedding assets. The consumers also have provided their corresponding expected generation or load shedding energy curtailment for each dispatch point. From this information, the LMD can calculate the proposed energy reduction. The LMD also has stored the contract terms the energy consumer has with its associated energy service provider. From the contract terms and the proposed energy reduction, the LMD can calculate estimates of the amount of financial gain to be achieved by a curtailment event. Step 710 is followed by step 715, in which the LMD retrieves the energy service provider notification information. Step 715 is followed by step 720, in which the LMD automatically performs the notification of a curtailment opportunity. The notification can be accomplished by an e-mail delivered by the Internet. Other notification means include an automatically generated telephone call, a facsimile, a wireless communication delivered via a wireless transmitter to a pager, mobile phone, or other wireless device, a wireless message delivery by wireless application protocol (WAP) to a hand held computing device, or other suitable methods for delivering message to the energy service provider.

Step 720 is followed by step 725, in which the LMD determines whether the ESP has responded to the curtailment opportunity notification. If the LMD has not received a response, the N (no) branch of step 725 is followed to step 730, in which the LMD has determined if the time limit for the receipt of a response has been exceeded. If the LMD has received a response, the Y (yes) branch of step 725 is followed to step 735, in which the LMD acts in accordance with the energy service provider response.

In step 730, the LDM determines whether the time limit for the receipt of a response by the energy service provider has been exceeded. If the time limit has not been exceeded, the N (no) branch of step 730 is followed to step 725, in which the LMD awaits a response. If the time limit has been exceeded, the Y (yes) branch of 730 is followed to step 720, in which the LDM provides another notification of the curtailment opportunity.

In step 735, LMD determines whether the energy service provider has decided to act on the curtailment opportunity. If the energy service provider has declined to proceed with a load management dispatch, the N (no) branch of step 735 is followed to step 740, in which the LDM updates a declined transaction file. In step 740, the LMD updates the declined transaction file. The declined transactions are logged to provide statistical and other information about declined curtailment opportunities. Step 740 is followed by step 745, in which the LMD closes the pending transaction file. After the performance of step 745, the routine is returned to perform step 650 of FIG. 6.

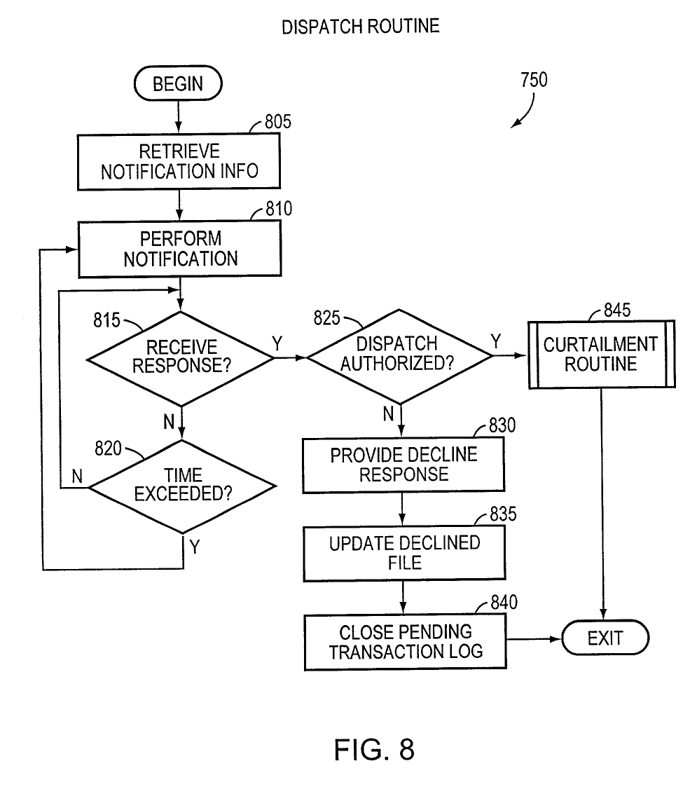

If the energy service provider has decided to proceed with the load management dispatch, the Y (yes) branch of step 735 is followed to routine 750, in which the LDM performs the dispatch notification. Routine 750 is described in greater detail in reference to FIG. 8. After the performance of routine 750, the routine is returned to perform step 650 of FIG. 6.

FIG. 8 illustrates an energy consumer dispatch notification routine 750, which is carried out in response to an energy service provider decision to proceed with a curtailment opportunity.

The routine begins with step 805, in which the LMD retrieves the notification information for a dispatch opportunity. Step 805 is followed by step 810, in which the automated notification of the energy consumer is performed. The notification can be accomplished by an e-mail delivered by the Internet. Other notification means include an automated telephone call, a facsimile, a wireless communication delivered via a wireless transmitter to a pager, mobile phone, or other wireless device, a wireless message delivery by wireless application protocol (WAP) to a hand held computing device, or other suitable methods for delivering message to the energy consumer.

Step 810 is followed by step 815, in which the LMD determines if the energy consumer has responded to the dispatch notification. If a response has not been received, the N (no) branch of step 815 is followed to step 820, in which the LDM determines whether the time limit for the receipt of a response has been exceeded. If the time limit has not been exceeded, the N (no) branch of step 820 is followed to step 815, in which the LMD awaits a response. If the time limit has been exceeded, the Y (yes) branch of 820 is followed to step 810, in which the LDM provides another notification of the dispatch opportunity. If a response has been received, the Y (yes) branch of step 815 is followed to step 825, in which the LDM determines if the dispatch is authorized.

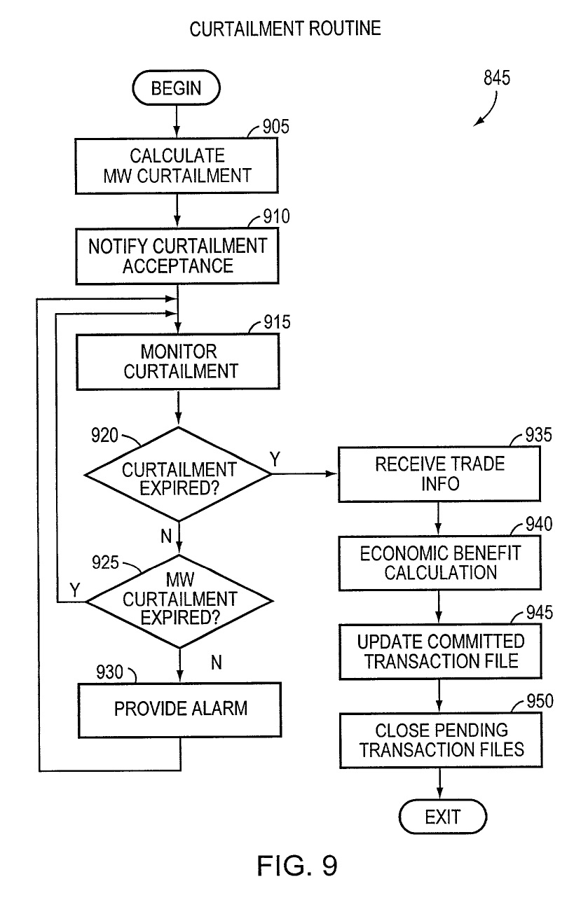

In step 825, the LDM determines whether a dispatch is authorized. If the dispatch is authorized, step 825 is followed by step 845, in which the LDM performs the curtailment routine. Routine 845 is described in greater detail in reference to FIG. 9. If the dispatch is not authorized, step 825 is followed by step 830, in which the LMD provides the energy service provider with notification of the energy consumer rejection of the dispatch opportunity. The dispatch rejection can be provided by e-mail or any other notification means sufficient to notify the energy service provider of the energy consumer s decision.

Step 830 is followed by step 835, in which the LMD updates the declined transaction log. The declined transaction log enables the LDM to easily retrieve information from declined transaction files about curtailment opportunities bypassed by the energy consumer. Step 835 is followed by step 840, in which the LMD closes the pending transaction file. After step 840, the routine is returned to perform step 650 of FIG. 6.

FIG. 9 illustrates a curtailment routine 845 performed by the LMD, the curtailment routine is initiated in response to the energy consumer authorizing an energy curtailment dispatch.

At step 905, the LMD calculates the expected energy curtailment. As part of the energy consumer's load management strategy, the reduction of load from the grid is established for each load shedding asset or on-site generation capability. The reductions from all of the accepted energy consumers are totaled by the LMD. Step 905 is followed by step 910, in which the energy service provider is notified of the energy consumer acceptance of the dispatch notification. Additionally, the LMD provides the energy service provider with the expected energy curtailment. This information can be delivered by email, displayed by the notification tool, or delivered by electronic file transfers. The energy service provider sells this aggregated reduction to energy buyers.

Step 910 is followed by step 915, in which the LMD monitors the curtailment. If the premise performing the load curtailment has an IP meter, the LMD can monitor the actual load reduction or on-site generation in real time via the Internet. Step 915 is followed by step 920, in which the LMD determines if the curtailment period has expired. The curtailment period is the time frame in which the energy consumer agreed to reduce its load because of the high market price. If the curtailment period has expired, the Y (yes) branch of step 920 is followed to step 935, in which the LMD receives the actual trade information. If the curtailment period has not expired, the N (no) branch of step 920 is followed to step 925, in which the LMD determines if the actual energy curtailment matches the expected energy reduction.

At step 925, the LMD determines whether the energy actual energy curtailment matches the expected energy curtailment. If the actual curtailment matches the expected curtailment, the Y (yes) branch of step 925 is followed to step 915, in which the LMD continues to monitor the curtailment. If a discrepancy exists between the actual and expected curtailment, the N (no) branch of step 925 is followed to step 930, in which the LMD provides an alarm to the energy consumer. The alarm is an automated notification performed in a similar manner as the notification of the dispatch opportunity. Step 930 is followed by step 915, in which the LMD continues to monitor the curtailment. At step 935, the LMD receives the actual trade information from the energy service provider or other energy market participant. The energy market participant supplies the LMD with the actual energy sold and the sell price. Step 935 follows by step 940, in which the LMD calculates the actual economic benefit for the energy consumer based upon the contract terms.

Step 940 is followed by step 945, in which the LMD updates a committed transaction file with the actual trade information and curtailment information. The energy consumer is able to view this information by accessing the dashboard via the Internet by the operation of a web browser. Step 945 is followed by step 950, in which the LMD closes the pending transaction file and the curtailment event is complete. After step 950 is performed, the routine is returned to perform step 650 of FIG. 6.

FIG. 10 illustrates an administrative routine 660 performed by the LMD in response to an administrative request. The LMD dashboard can be accessed through a request via the Internet from a web browser. The dashboard enables a user of the dashboard to access load management information. A screen shot of the dashboard graphical interface is described in greater detail in reference to FIG. 11.

Step 1005 displays the dashboard in response to a request from a web browser via the Internet. The dashboard displays price summary information as well as trade history information. Step 1005 is followed by step 1010, in which the LMD determines whether the user requests price summary information. If price summary information is not requested, the N (no) branch of step 1010 is followed to step 1030, in which the LMD determines whether the user requests trade history information.

If price summary information is requested, the Y (yes) branch of step 1010 is followed to step 1015, in which the LMD determines whether the user has specified a date range. If a date range has been specified, the Y (yes) branch of 1015 is followed to 1020, in which the dashboard displays price information from a selected market for the dates selected. If a date range has not been specified, the N (no) branch of 1015 is followed to 1025, in which the dashboard displays price information from the selected market for the current date. Both step 1020 and step 1025 are followed by step 1030, in which the LMD determines whether the user has requested to display the trade history.

At step 1030, the LMD determines whether the user has requested to display the trade history. If a trade history has been requested the Y (yes) branch of step 1030 is followed to step 1035, in which the dashboard displays the user's trade history. The trade history displays the date of the trade, the hour, the traded price, and the traded energy in megawatts. The trade history screen also provides to a user the means to record new trades. If a trade history has not been requested the N (no) branch of step 1030 is followed to step 1040, in which the LMD determines if the user has requested to change the alarm setpoint.

At step 1040 the LMD determined whether the user has requested a new alarm setpoint. If a new alarm setpoint has been requested the Y (yes) branch of step 1040 is followed to step 1045. In step 1045, a new alarm setpoint is received. The LMD verifies that the user has the authority to change the alarm setpoint for the ESP. The dashboard displays market prices above the alarm setpoint in red for easy viewer identification of dispatch opportunities at the selected alarm setpoint. If a new alarm dashboard setpoint has not been requested, the N (no) branch of step 1040 is followed to step 1050, in which the LMD determines if the user requested a change of password.

At step 1050, the LMD determines whether the user has requested to change a password. If the user has not requested a password change, the routine is returned to perform step 610 of FIG. 6. If the user has requested a password change, step 1050 is followed to step 1055, in which the LMD determines if the password change request is valid.

The LMD performs a check to determine if the new password meets minimum security requirements, and if the user successfully duplicated the password to ensure the entered password was indeed the intended password.

If the password request was not valid, step 155 is followed by step 1065, in which the password is not change and the user is asked for a new password. Step 1065 is followed by step 1055, in which the LMD determines if the new password is valid.

If the password request was valid, the Y (yes) step 1055 is followed to step 1060, in which the LMD accepts the new password for future logins by that user. After step 1060, the routine is returned to perform step 610 of FIG. 6.

FIG. 11 begins a series of exemplary computer generated screen shots or user interface displays constructed in accordance with an embodiment of the invention. Those skilled in the art will understand that the LMD is operative to display such information as shown in the series of screen shots and receive user commands via well-known Internet browser methodologies.

Turning to FIG. 11, the screen shot illustrates an Internet web page 1100 displayed by the LMD in response to a login from an energy service provider user. The dashboard 1100 displays information associated with the user. The dashboard displays the associated energy service provider logo 1105. The dashboard includes an energy display region 1120 that displays energy prices. The energy pricing defaults to the current date and the hourly price from the current time to 10 p.m. A scroll down bar 1150 also allows the user to view the hourly prices from 6 a.m. to 8 p.m. for the next two days. The energy market to be displayed in the energy display region 1120 can be chosen from a drop down list by the operation of a pricing source button 1110. A history button 1115 will provide the user with another screen, in which the user can specify a past date for viewing hourly price information in the price display area. The dashboard includes a dashboard alarm button 1115 in which the user can change the alarm setpoint setting. Prices exceeding the alarm price are displayed in red in the energy pricing region.

The dash board 1100 includes a system message region 1155. The system message region 1155 displays the last system message. System messages can include connection dropped warnings, messages relating to the unavailability of sought information, or that the system communications are functioning as expected. For example, if the LMD could not establish connection with an energy market, a system message would be generated. A system message review button 1170 pops up another window that allows the user to view all the past system messages.

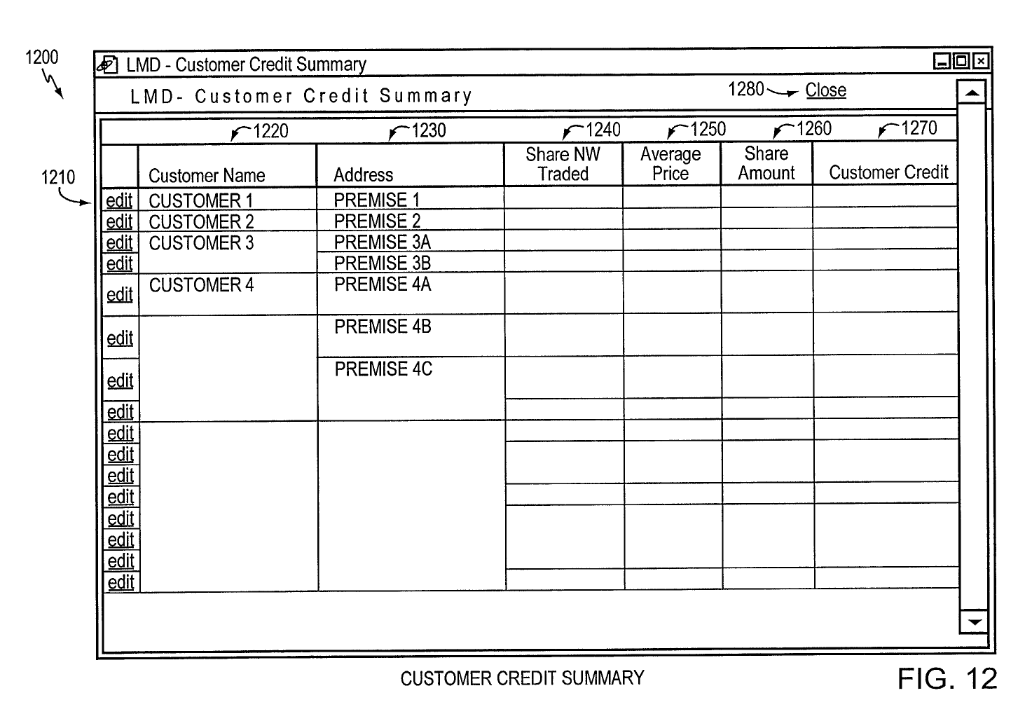

The dashboard 1100 includes a savings and credit region 1160. The savings and credit region 1160 displays the total credit to the energy consumers in dollars and the total company savings in dollars. A savings and credit details button 1130 pops up a customer credit summary screen. The customer credit summary screen list each of the energy service provider's customer. Associated with each customer is the energy consumer's energy traded, the average price, the revenue split , the total credit for that consumer. The customer credit screen is illustrated in reference to FIG. 12.

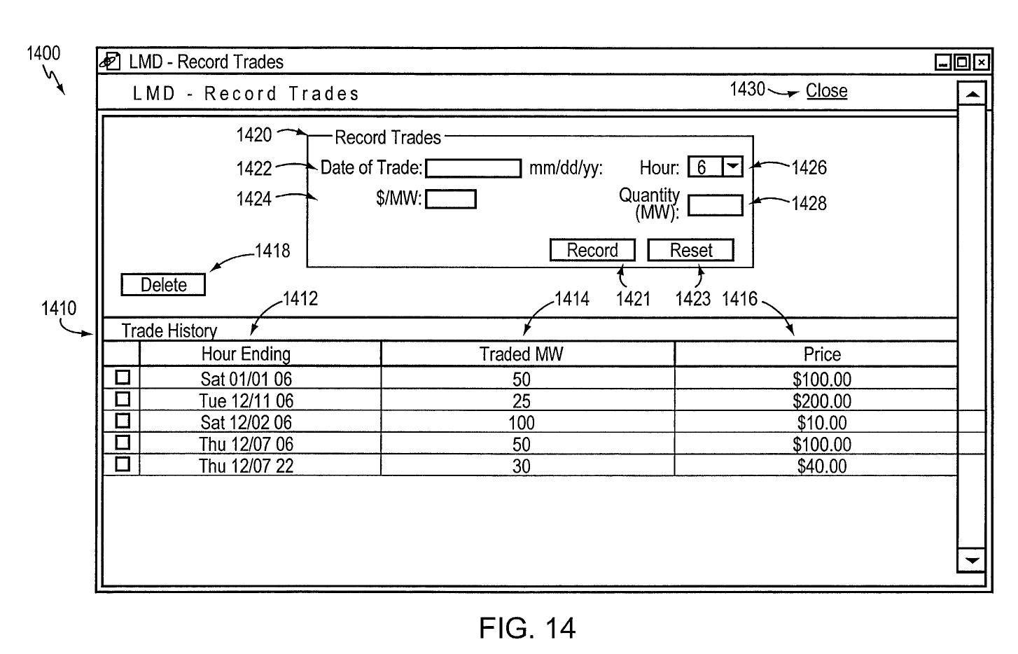

The dashboard 1100 also includes a trading total region 1165. The total trading region 1165 displays the total energy traded and the average price per megawatt by the energy service provider in that day and in the year to date. The trading total regions also includes an add/view trades button 1135. The add/view trades button 1135 pops up a trade display screen that enables the energy service provider to add new trade information. The trade display screen also list all the trades, the associate traded energy amount, the ending hour of the trade, and the price for the trade. The trade display screen also allows the user to delete any trade record. The trade display screen is illustrated in reference to FIG. 14.

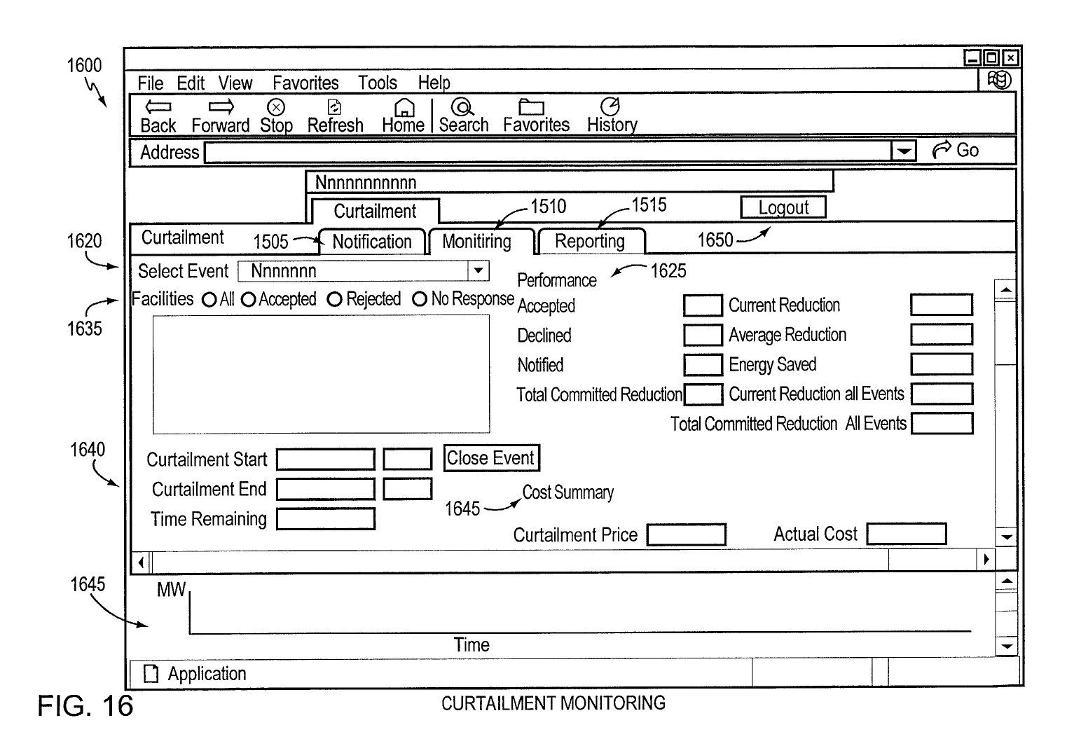

The dashboard 1100 also includes a menu button 1125 that allows the user to chose any of the pop up screens associated with the dashboard 1100. In addition, the dashboard 1100 includes a load curtailment operations hyperlink 1140. Obviously, a hyperlink would be unnecessary if all of the operations screens reside in one environment. The load curtailment operations screens is discussed in greater detail in reference to FIG. 15 and FIG. 16.

FIG. 12 illustrates an exemplary customer credit summary page 1200. The customer credit summary page 1200 is displayed in response to a selection of the customer credit from the customer option of the drop down menu 1125 (FIG. 11) or from the savings and credit details button 1130 (FIG. 11). The customer credit summary page has a column to enter each energy consumer under the customer name column 1220. For example, Customer 1 through Customer 4 have been entered and associated with this energy service provider. Column 1230 accepts the address for each premise associated with each customer. For example, customer 4 has associated premises 4A through 4C. The customer credit summary 1200 also associates the energy traded, price, share amount and the customer credit with each premise and corresponding customer. Column 1240 displays the energy trade for that premise, while column 1250 displays the corresponding average price for all of its energy trades. Column 1260 displays the share amount or the split the energy consumer receives from an energy trade, which is based upon the contract with the customer. The customer credit column 1270 displays the calculated credit the energy consumer will receive based upon the share amount. The customer credit summary page has a row of edit buttons 1210 that enables the user to select that line for editing information. Information can be entered or modified as needed. Additionally, the customer credit summary has a close button 1280 that closes the page and returns the user to the dashboard 1100 (FIG. 11).

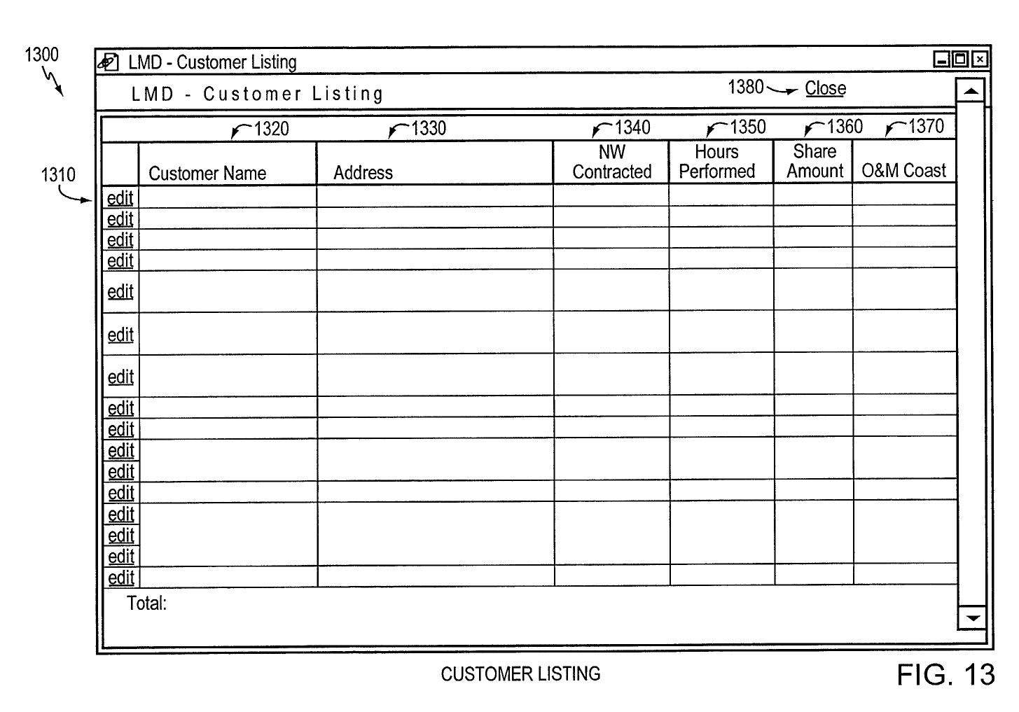

FIG. 13 illustrates an exemplary customer listing page 1300, displayed in response to a selection of the customer credit from the customer option of the drop down menu 1125 (FIG. 11). The customer listing page has a column to enter each energy consumer under the customer name column 1320. Column 1330 accepts the address for each premise associated with each customer. The customer listing page 1300 also associates the energy contracted, hours performed, share amount, and the operation cost associated with each premise and corresponding customer. Column 1340 displays the load curtailment energy contracted by that premise, while column 1350 displays the corresponding hours performed of its energy trades. Column 1360 displays the share amount or the split the energy consumer receives from an energy trade, which is based upon the contract with the customer. The operation cost column 1370 displays the cost associated with deploying the load management by the energy consumer The customer listing page has a row of edit buttons 1310 that enables the user to select that line for editing information. Information can be entered or modified as needed. Additionally, a close button 1380 closes the page and returns the user to the dashboard 1100 (FIG. 11).

FIG. 14 illustrates an exemplary view trades page 1400. The view trades page 1400 is displayed in response to a selection of trades option from the drop down menu 1125 (FIG. 1) or from the add/view trades button 1135 (FIG. 11). The view trades page 1400 displays the trading history of the user and allows for the recordation of new trades. The trade history region 1410 lists the trades performed. Trade information includes a row for each trade event. A trade event has an associated date with ending hour displayed in the hour ending column 1412, the energy traded displayed in the MW traded column 1414, and the corresponding price displayed in the price column 1416. By scrolling down through the trade history information, the user can view all of the trades. The view trades page 1400 also includes a delete button 1418 that deletes selected trade events. Additional, trades can be recorded in the record trades region 1420. The user enters the date in date of trade field 1422, the price in the price field 1424, the hour in the hour field 1426, and the associated quantity of energy sold in the quantify field 1428. After the user has entered the trade information, the user may reset the information if in error by activating the reset button 1423 or record the information by activating the record button 1421. Additionally, a close button 1430 closes the view trade page 1400 and returns the user to the dashboard 1100 (FIG. 11).

FIG. 15 illustrates an exemplary curtailment notification page 1500, displayed in response to an activation of the load curtailment operation hyperlink 1140 from the dashboard 1100 (FIG. 11). The load curtailment notification page 1500 can be used by the energy service provider to notify selected energy consumers of a dispatch opportunity. The load curtailment notification page 1500 displays the curtailment notification event information 1525. This information includes the curtailment start time, curtailment end time, the curtailment price, and the time in which a response to the notification is needed. The curtailment notification event notification information 1525 displays whether the curtailment is voluntary or mandatory. A voluntary curtailment notification indicates that the energy consumer can contractual reject the dispatch notification. The notification page 1500 includes a select program drop down list 1520 that enables the user to select the program type desired. For example, the program type can be all voluntary curtailments, voluntary curtailments within certain cost parameter, mandatory curtailments, residential curtailments, and the like. The selected program will display the facilities meeting the selected program criteria. The facilities will be displayed in the facilities display region 1535. The user can select in a known manner the facilities for which the LMD will notify a dispatch opportunity upon submittal. The submittal is performed by the activation in known manner the submit curtailment notice button 1530. The LMD will perform an automated notification of the selected facilities.

The curtailment notification page 1500 displays the total selected megawatts per hour 1540 along with the estimated energy reduction 1545. A curtailment event chart 1550 displays the megawatts for each hour for the facilities selected. The notification page also displays the prior curtailment history 1555. The curtailment history displays recent similar events including the date of the event, duration, price, response rate by the customers, average reduction, and the associated curtailment cost. This historical information will provide the user with information to forecast the acceptance of this curtailment event by the energy consumers.

The user may select between different load curtailment operation pages by the activation of buttons for the various associated functions. Activation of notification page button 1505 displays the curtailment notification page 1500. Likewise, activation of the monitoring button displays the monitoring page. The monitoring page monitors the actual performance of the energy consumer. The monitoring page is described in greater detail in reference to FIG. 16. Also, activation of the reporting button 1515 will display a page summary curtailment events. The user may return to the dashboard by activating the logout button 1560.

FIG. 16 illustrates an exemplary curtailment monitoring page 1600, displayed in response to an activation of the curtailment monitoring button 1510 (FIG. 15). The user selects the curtailment event for monitoring by selecting from a drop down window in the select event region 1620. The curtailment monitoring displays the energy curtailment versus time for the selected facilities in the curtailment monitoring region 1645. The facilities to be monitored can be selected in the facilities region 1635. The facilities to be displayed can be chosen by selecting the facilities based upon the dispatch notification response from the energy consumer. From the displayed list of facilities, any facility can be selected by double clicking on that facility for individual monitoring. The monitoring page further displays the curtailment start time, end time, and time remaining in the time region 1640 for the curtailment event.

The monitoring page summarizes the performance of the energy consumers in the performance region 1625 of the monitoring page 1600. The performance monitoring region 1625 displays the accepted committed energy, the declined energy opportunities, and the total energy opportunity for the notified energy consumers. Likewise, the performance monitoring region 1625 displays the current reduction, average reduction, and the energy saved for this curtailment event. All events' summaries are also displayed. The actual current reduction for all events as well as the total committed reduction for all events are displayed. The actual current reduction for all events is the amount of energy that can be actually sold on the market. If the actual provided energy is more or less than predicted, the energy service provider can adjust its non-firm commitments or make up the balance on the imbalance or spot market.

In the cost summary section 1630, the curtailment monitoring page 1600 displays the actual cost to the energy service provider for the curtailment and the curtailment price that will be received by the energy service provider.

The user may proceed back to the notification page (FIG. 1500) by activating the notification button 1505. The user may return to the dash board by activating the logout button 1650.

In view of the foregoing, it will be appreciated that the invention provides for a load management dispatch system and methods. It should be understood that the foregoing relates only to the exemplary embodiments of the present invention, and that numerous changes may be made therein without departing from the spirit and scope of the invention as defined by the following claims. Accordingly, it is the claims set forth below, and not merely the foregoing illustration, which are intended to define the exclusive rights of the invention.

The invention claimed is:

1. A method for energy load curtailment, comprising the steps of:
obtaining energy market buying prices;
obtaining an economic setpoint based upon a cost associated with an energy load reduction by an energy consumer;
comparing the energy market buying prices and the economic setpoint; and
transmitting a notification indicating that the energy market buying prices has exceeded the economic setpoint.

2. The method of claim 1, wherein the step of obtaining the economic setpoint includes obtaining said economic setpoint from an energy market participant.

3. The method of claim 1, wherein the step of obtaining the economic setpoint includes obtaining said economic setpoint from the energy consumer.

4. The method of claim 1, wherein the step of obtaining the economic setpoint includes obtaining said economic setpoint from an energy provider.

5. The method of claim 1, wherein the step of obtaining an economic setpoint includes obtaining the economic setpoint of operating an energy consumer's onsite power generator.

6. The method of claim 1, wherein the step of obtaining an economic setpoint includes obtaining the economic setpoint of employing an energy consumer's onsite battery supply.

7. The method of claim 1, wherein the step of obtaining an economic setpoint includes obtaining the economic setpoint of consuming an energy consumer's onsite supply of stored gas.

8. The method of claim 1, further comprising the step of receiving energy load reduction information.

9. The method of claim 8, wherein the step of receiving energy load reduction information includes receiving meter readings in near real time.

10. The method of claim 8, wherein the step of receiving energy load reduction information includes obtaining via a global computer network meter readings from a database.

11. The method of claim 8, further including the step of calculating payment information based upon the energy load reduction information.

12. The method of claim 11, wherein the step of calculating the payment information includes calculating a credit to be applied to a bill for the energy consumer.

13. The method of claim 11, further including the step of transmitting the payment information to an energy market participant.

14. The method of claim 1, further comprising the step of transmitting a signal that will result in energy load reduction by the energy consumer.

15. The method of claim 14, wherein the step of transmitting the signal includes transmitting said signal that automatically starts an onsite power generator associated with the energy consumer.

16. The method of claim 14, wherein the step of transmitting the signal includes transmitting said signal that automatically connects an energy consuming source associated with the energy consumer to an energy storage device.

17. The method of claim 14, wherein the step of transmitting the signal includes transmitting said signal that automatically sheds an energy consuming source associated with the energy consumer.

18. The method of claim 14, wherein the step of transmitting the signal includes transmitting said signal that shuts down an assembly line associated with the energy consumer.

19. The method of claim 14, wherein the step of transmitting the signal includes transmitting said signal that shuts a facility associated with an energy consumer.

20. The method of claim 14, wherein the step of transmitting the signal includes transmitting said signal that automatically provides a gas consuming device associated with the energy consumer with an onsite supply of gas.

21. The method of claim 1, wherein the step of obtaining energy market prices includes receiving the energy market prices via the Internet.

22. The method of claim 1, wherein the step of obtaining energy market prices includes obtaining a buying price by an energy provider.

23. A method for energy load curtailment, comprising the steps of:
obtaining energy market buying prices;
transmitting a notification indicating that the energy market buying prices has exceeded a profit margin obtainable by an energy consumer through the use of supplied energy made available by an energy provider; and
receiving an authorization to sell at least some of the supplied energy to an energy market.

24. The method of claim 23, wherein the step of transmitting the notification includes transmitting said notification to an energy market participant.

25. The method of claim 24, wherein the step of transmitting the notification includes transmitting said notification to an energy provider.

26. The method of claim 24, wherein the step of transmitting the notification includes transmitting said notification to an energy consumer.

27. A method for energy load curtailment, comprising the steps of:
obtaining energy market buying prices;
transmitting a notification indicating that the energy market buying prices has exceeded a cost associated with energy load reduction by an energy consumer; and
receiving an authorization to sell energy associated with the energy load reduction.

28. The method of claim 27, wherein the step of transmitting the notification includes transmitting said notification to an energy market participant.

29. The method of claim 27, wherein the step of transmitting the notification includes transmitting said notification to an energy provider.

30. The method of claim 27, wherein the step of transmitting the notification includes transmitting said notification to an energy consumer.

31. A method for energy load curtailment, comprising the step of:
receiving energy market buying price information via a computer network;
storing in a computer retrievable medium an economic setpoint based upon a cost associated with a predetermined load reduction by at least one energy consumer;
comparing by an automated process the energy market prices to the economic setpoint; and
providing an automated notification that the market prices has exceeded the economic setpoint.

32. The method of claim 31, wherein the step of receiving the economic setpoint via a computer network includes receiving said economic setpoint via a global computer network commonly referred to as the Internet.

33. The method of claim 31, wherein the step of receiving the economic setpoint includes receiving said economic setpoint from the energy consumer.

34. The method of claim 31, wherein the step of receiving the economic setpoint includes receiving said economic setpoint from an energy provider.

35. The method of claim 31, further comprising the step of receiving energy load reduction information via a computer network.

36. The method of claim 35, wherein the step of receiving energy load reduction information includes receiving meter readings in near real time.

37. The method of claim 35, wherein the step of receiving energy load reduction information includes receiving the energy load reduction information via a global computer network from a database storing meter readings.

38. The method of claim 35, further including the step of calculating payment information based upon the energy load reduction information.

39. The method of claim 38, wherein the step of calculating a payment information includes calculating a credit to be applied to a bill for the energy consumer.

40. The method of claim 38, further including the step of transmitting the payment information to an energy market participant via a computer network.

41. The method of claim 31, further comprising the step of transmitting a signal that will result in the energy load reduction by the energy consumer.

42. The method of claim 41, wherein the step of transmitting the signal includes transmitting said signal that automatically starts an onsite power generator associated with the energy consumer.

43. The method of claim 41, wherein the step of transmitting the signal includes transmitting said signal that automatically connects an energy consuming source associated with the energy consumer to an energy storage device.

44. The method of claim 41, wherein the step of transmitting the signal includes transmitting said signal that automatically sheds an energy consuming source.

45. The method of claim 41, wherein the step of transmitting the signal includes transmitting said signal that shuts down an assembly line.

46. The method of claim 41 , wherein the step of transmitting the signal includes transmitting said signal that shuts a facility.

47. The method of claim 41, wherein the step of transmitting the signal includes transmitting said signal that provides an energy consuming source associated with the energy consumer with onsite supply of gas.

48. A system for energy load curtailment, comprising:
a computer system operative to receive an economic setpoint based upon a cost associated with an energy load reduction of an energy consumer;
the computer system operative to receive energy market buying prices via a communication network;
a database coupled to the computer system operative to store and retrieve the economic setpoint; and
the computer system is operative to compare the energy market buying prices to the economic setpoint; and
a communication mechanism coupled to the computer system operative to notify the energy market participant of an economic opportunity when the market buying prices exceeds the economic setpoint.

49. The system of claim 48, wherein the communication network is a global computer network.

50. The system of claim 48, wherein the communication mechanism is a modem coupled to a telephone system.

51. The system of claim 48, wherein the communication mechanism is a network interface to a global computer network.

52. A system for energy load curtailment, comprising:
a computer system operative to compare energy market buying prices to an economic setpoint based upon the cost associated with a load reduction by an energy consumer;
a communication mechanism coupled to the computer system operative to transmit notification indicating that the energy market buying prices has exceeded the economic setpoint; and

53. The system of claim 52, wherein the communication mechanism is a modem coupled to a telephone system.

54. The system of claim 52, wherein the communication mechanism is a network interface to a global computer network.

55. A system for energy load curtailment, comprising:
a computer system operative to compare energy market buying prices to an economic setpoint based upon the cost associated with a load reduction by an energy consumer;
a communication mechanism coupled to the computer system operative to transmit notification indicating that the energy market buying prices has exceeded the economic setpoint; and
the communication mechanism operative to receive an authorization to sell energy associated with the energy load reduction.

56. The system of claim 55, wherein the communication mechanism is a modem coupled to a telephone system.

57. The system of claim 55, wherein the communication mechanism is a network interface to a global computer network.

58. A system for energy load curtailment, comprising:
a computer system operative to compare energy market buying prices to an economic setpoint based upon the cost associated with a load reduction by an energy consumer;
the computer system operative to generate a signal indicating that the market buying prices has exceed the economic setpoint; and
a communication mechanism coupled to the computer system operative to transmit the signal.

59. The system of claim 58, wherein the signal is operative to automatically initiate a load curtailment by the energy consumer.

60. The system of claim 58, wherein the communication mechanism is a modem coupled to a telephone system.

61. The system of claim 58, wherein the communication mechanism is a network interface to a global computer network.
